(19) United States
(12) Patent Application Publication
(10) Pub. No.: US 2018/0318756 A1
(43) Pub. Date: Nov. 8, 2018

(54) PROCESS FOR REMOVING MERCAPTANS FROM A GAS STREAM

(71) Applicant: SHELL OIL COMPANY, Houston, TX (US)

(72) Inventor: Sipke Hidde WADMAN, Amsterdam (NL)

(21) Appl. No.: 15/774,026

(22) PCT Filed: Nov. 9, 2016
(86) PCT No.: PCT/EP2016/077173

§ 371 Date: May 7, 2018

(30) Foreign Application Priority Data
Nov. 9, 2015 (EP) 15193683.8

(51) Int. Cl. B01D 53/14; B01D 53/48

(52) U.S. Cl. CPC B01D 53/1487; B01D 2252/204; B01D 2257/306; B01D 53/48

(57) ABSTRACT

The present invention provides a process for removing mercaptans from a gas stream. A first mercaptan-comprising gas stream is contacted counter-currently with an absorption medium comprising a substituted disulphide and a nitrogen-containing base to obtain a second mercaptan-depleted gas stream. The substituted disulphinde preferably is R_{II}—SS—R_{III} wherein: R_{II} and R_{III} are the same and are selected from: —(CH₂)n-X, wherein n=2 or 3, and wherein X=OR, and wherein R=H or —(CH₂O)ₙH or —(CH₂O)nCH₃ and n=1 or 2. Absorption medium is regenerated and recycled.

### FIELD OF THE INVENTION

The invention relates to a process for removing mercaptans from a gas stream.

### BACKGROUND TO THE INVENTION

Natural gas comprises mainly methane and can further comprise other components such as higher hydrocarbons (e.g. ethane, propane, butanes, pentanes). In addition, it may also comprise significant amounts of undesired sulphur contaminants and carbon dioxide. Common sulphur contaminants are hydrogen sulphide (H₂S), mercaptans (RSH), also referred to as thiols, and carbonyl sulphide (COS).

One process for removing hydrogen sulphide, COS and carbon dioxide uses an amine-containing absorption liquid based on a chemical absorbent, also referred to as selective amine absorption process. In this process, a gas stream comprising hydrogen sulphide, COS and carbon dioxide is contacted with the amine-containing absorption liquid in an absorption unit, also referred to as amine treating unit. The hydrogen sulphide, COS and carbon dioxide are selectively absorbed in the amine-containing absorption liquid and thereby removed from the gas stream.

A disadvantage of such a process is that it does not provide an efficient absorption of mercaptans.

A well known adaption of this selective absorption process is obtained by using an amine-containing absorption liquid based on a mixed absorbent, i.e. a mixture comprising both a chemical absorbent and a physical absorbent, e.g. sulfinol. Such a mixed absorption liquid can also capture the mercaptans from the gas stream. Such a process is for instance described in WO2010060975. A disadvantage of the use of mixed absorption liquids is that also C2⁺ hydrocarbons, also referred to as condensates are absorbed together with the sulphur contaminants and the carbon dioxide. As these condensates are valuable products, an additional separation of the condensates from the sulphur contaminants and the carbon dioxide is required.

Alternatively, a natural gas, from which the hydrogen sulphide and carbon dioxide have been removed by for instance treatment with a selective amine absorption process, is further treated to remove mercaptans by a process as for instance provided in U.S. Pat. No. 4,705,620. In this process, which is typically used to remove mercaptans from LPG, propane, butanes, light naphthas, kerosene and jet fuel, the mercaptans are removed by converting them by oxidation to liquid hydrocarbon disulfides. The mercaptans are reacted in water with a stoichiometric amount of caustic to form the corresponding sodium salts, e.g. CH₃—S—Na. This salt is oxidized with air to form a disulphide, e.g. CH₃—SS—CH₃, and NaOH, which will be recycled. A disadvantage of this process is its large sensitivity to the presence of hydrogen sulphide and carbon dioxide. Being acids, these compounds react with the caustic, thereby irreversibly consuming the caustic. Therefore, such a mercaptan oxidation process is always preceded by a hydrogen sulphide and carbon dioxide removal unit, such as a selective amine absorption, as described herein above. Even with a hydrogen sulphide and carbon dioxide removal pre-treatment, caustic consumption remains significant due to residual hydrogen sulphide and carbon dioxide in the feed to the oxidation process.

In GB1551344, a process is described using (non-aqueous) liquid organic disulfide mixtures as a solvent to absorb contaminating gaseous sulphur compounds from gas streams, e.g. hydrogen sulfide and sulphur dioxide. However, this was found to lead to less selectivity for removal of H₂S over CO₂. In contrast, according to the present invention, the presence of at least catalytic amounts of a nitrogen-containing base is necessary for efficient removal of mercaptans.

Further, WO2009156621 describes an absorbent solution for deacidification of gaseous effluents. WO2009156621 specifically deals with a reported degradation inhibitory activity of certain organosulphur compounds bearing a carbonyl group. Among the suggested compounds that may be used as amine degradation inhibitor are 3-mercapto-2-butanone, N-(methyl) mercaptoacetamide, 2-mercaptoacetate of isopropyl, 2-mercaptopropionate, and mercaptosuccinic acid. WO2009156621 does not disclose findings relating to the removal of mercaptans from gaseous effluents for the described absorbent solution.

Processes for removing hydrogen sulfide, COS and carbon dioxide are known which use an amine-containing absorption liquid based on a chemical absorbent, also referred to as selective amine absorption process. In such a process, a gas stream comprising hydrogen sulfide, COS and carbon dioxide is contacted with the amine-containing absorption liquid in an absorption unit, also referred to as amine treating unit. The hydrogen sulfide, COS and/or carbon dioxide are selectively absorbed (by a chemical, acid-base, interaction with the amine mix) in the amine-containing absorption liquid and thereby removed from the gas stream. However, a disadvantage of such a process is that it does not provide an efficient absorption of mercaptans. Mercaptans, having a much higher pKa than e.g H₂S, do not show chemical interaction with the amine mix to such an extent that they can be effectively removed in that process. Mercaptans are only partly removed by physical interaction with the absorbent (solution/dissolution process).

In a recently developed process mercaptan contaminants may be removed from a gas stream through a reversible chemical reaction by contacting the mercaptan-comprising natural gas stream with an absorption medium comprising a specific substituted organic disulfide in combination with at least catalytic amounts of a base. This is described in WO2012076378 and WO2012076502. This process is selective for mercaptans, without absorbing condensate/gas. The processes of WO2012076378 and WO2012076502 are based on chemical interaction of mercaptans with the organic disulfide rather than by physical interaction with the absorption medium (i.e. solubility). Mercaptans in the gas stream react with said disulfides to reversibly form “new” mixed disulfide products and a “new” thiol (e.g. MeSH+RSSR<=>MeSSR+RSH). As that reaction is an equilibrium reaction, regeneration into the original disulfides is achieved by removal of the mercaptan (MeSH in the example given above) from the absorption medium, preferably using a strip gas at elevated temperatures. However, it has now been found that the reverse reaction to regenerate the original disulfides is slower than expected. It was further found that this results in build-up of amounts of the “new” thiol in the regenerated absorption medium and undesired consumption of the organic disulfide during the mercaptan removal process.

An optimized process to solve the problems of build-up of the “new” thiol and the undesired disulfide consumption is described in WO2015071226. The thiols are re-oxidized. The agent used for the re-oxidation may be selected from H₂O₂, organic peroxides, iodine, amine-N-oxides, nitrogen oxides, sulphur, sulphur dioxide, (a gas containing free) oxygen, and air. Preferably air is used. This process thus requires the extra step of re-oxidation.

There is a need for a simpler process to avoid the problems of build-up of the “new” thiol and the undesired disulfide consumption in processes as described in processes of WO2012076378 and WO2012076502.

### SUMMARY OF THE INVENTION

The present invention provides a process for removing mercaptans from a gas stream gas stream, comprising the steps:

a) providing a first mercaptan-comprising gas stream comprising at least a mercaptan of the general formula:

R_{I}—SH,

wherein R_{I} is an alkyl group comprising 1 to 4 carbon atoms; and
b) contacting the mercaptan-comprising gas stream counter-currently with an absorption medium comprising
a substituted disulphide, and
a nitrogen-containing base in an amount of at least 3 mol % with regard to the amount of the substituted disulfide
   to obtain a second mercaptan-depleted gas stream,
   c) retrieving the absorption medium from step b);
   d) regenerating the absorption medium;
   e) providing the regenerated absorption medium to step b);
   wherein:
   the amount of the substituted disulphide constitutes 0.001-10% m/m of the absorption medium; and the substituted disulphide is of the general formula

R_{II}—SS—R_{III}

wherein:
R_{II} and R_{III} are carbon comprising substituents, which may be the same or different, and
wherein R_{II} and R_{III} are selected from:

—(CH₂)ₙ—X

wherein n=1, 2 or 3, preferably 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2
   or
   wherein R_{II} and R_{III} are selected from:

—(CH₂)ₙ—CH(X)—(CH₂)ₘ—CH₃
wherein n=0, 1, 2, or 3 and m=0, 1, 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2.

The process according to the present invention allows for the reversible absorption of mercaptans from the natural gas and efficient purification thereof.

Additionally, the process according to the invention provides the possibility of reducing any hydrogen sulphide, carbon dioxide, water and/or COS content in the natural gas. It may be incorporated into existing selective amine process thereby omitting the need to subject the natural gas stream to a prior hydrogen sulphide and carbon dioxide removal process.

It has now been found that with the present invention, with counter-current contacting and using a specific aliphatic disulfide, the re-oxidation step as described in WO2015071226 is not necessary.

Build-up of “new” thiol and undesired disulfide consumption are avoided.

The process of the present invention thus is an improvement of the processes described in WO2012076378 and WO2012076502.

### DETAILED DESCRIPTION OF THE INVENTION

The present invention relates to a process for removing mercaptans from a gas stream gas stream, comprising the steps:

a) providing a first mercaptan-comprising gas stream comprising at least a mercaptan of the general formula:

R_{I}—SH,

wherein R_{I} is an alkyl group comprising 1 to 4 carbon atoms; and
b) contacting the mercaptan-comprising gas stream counter-currently with an absorption medium comprising
a substituted disulphide, and
a nitrogen-containing base in an amount of at least 3 mol % with regard to the amount of the substituted disulfide
   to obtain a second mercaptan-depleted gas stream,
   c) retrieving the absorption medium from step b);
   d) regenerating the absorption medium;
   e) providing the regenerated absorption medium to step b);
   wherein:
   the amount of the substituted disulphide constitutes 0.001-10% m/m of the absorption medium; and the substituted disulphide is of the general formula

R_{II}—SS—R_{III}

wherein:
R_{II} and R_{III} are carbon comprising substituents, which may be the same or different, and
wherein R_{II} and R_{III} are selected from:

—(CH₂)ₙ—X

wherein n=1, 2 or 3, preferably 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2
   or
   wherein R_{II} and R_{III} are selected from:

—(CH₂)ₙ—CH(X)—(CH₂)ₘ—CH₃
wherein n=0, 1, 2, or 3 and m=0, 1, 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2.

The mercaptan-comprising gas steam comprises at least mercaptans of the general formula:

R_{I}—SH (1)

wherein R_{I} is an alkyl group comprising 1 to 4 carbon atoms.

A re-oxidation step as described in WO2015071226 is not necessary.

In a preferred embodiment of the present invention the regenerated absorption medium obtained in step d) is not subjected to oxidation before step e). The regenerated absorption medium thus preferably is not subjected to oxidation before providing the regenerated absorption medium to step b).

Reference herein to mercaptans (R—SH) is to aliphatic mercaptans. The invention especially involves removal of methyl mercaptan (R=methyl), ethyl mercaptan (R=ethyl), normal- and iso-propyl mercaptan (R=n-propyl and i-propyl) and butyl mercaptan (R=butyl) isomers. These mercaptans have vapour pressures the range of from 5 to 210 kPa measured at 25° C.

In step (b) of the process according to the invention the mercaptan-comprising gas stream is contacted with an absorption medium. The absorption medium comprises a substituted disulphide of the general formula:

R_{II}—SS—R_{II} (2)

wherein:
R_{II} and R_{III} are carbon comprising substituents, which may be the same or different, and
wherein R_{II} and R_{III} are selected from:

—(CH₂)ₙ—X

wherein n=1, 2 or 3, preferably 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2
   or
   wherein R_{II} and R_{III} are selected from:

—(CH₂)ₙ—CH(X)—(CH₂)ₘ—CH₃
wherein n=0, 1, 2, or 3 and m=0, 1, 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2.

R_{II} and R_{III} may be the same or different. In case R_{II} and R_{III} are the same, the variety of thiols formed is reduced, making the selection of the operation conditions and optional regeneration conditions easier.

Preferably the substituted disulphide is water soluble at the conditions at which the absorption medium is used in the present invention. Preferably the substituted disulfide comprises one or more COH groups or one or more COOH groups, preferably two COH groups or two COOH groups. When the substituted disulfide comprises acid groups, it is suitable to use salts thereof, preferably potassium or sodium salts thereof.

According to the invention, the amount of the substituted disulphide in the absorption medium used in the process of this invention is chosen on the basis of at least equimolarity to the amount of the mercaptan that is to be removed. The amount of the substituted disulphide constitutes 0.001-10% m/m of the absorption medium used in the process of this invention, preferably 0.01-10% m/m and more particularly 0.01-5% m/m.

The absorption medium comprises a nitrogen-containing base. Preferably, the base is an amine-containing base. The nitrogen-containing base catalyses the reaction between the substituted disulphide and the R_{I}SH mercaptan. In the absence of a nitrogen-containing base the reaction proceeds hardly notable. Therefore, according to the present invention, at least a catalytic amount of the nitrogen-containing base must be present in the absorption medium, wherein the term “catalytic” refers to the action of the base to significantly accelerate (meaning an acceleration of time of reaction with a factor of more than 10, preferably more than 100) the reaction between the R_{I}SH mercaptan and the substituted disulphide. To such extent, an amount of at least 3 mol %, preferably at least 5 mol % of the nitrogen-containing base should be present with regard to the amount of the substituted disulphide. In addition, the nitrogen-containing base may reversibly react with acid components in the mercaptan-comprising gas stream, such as any hydrogen sulphide, carbon dioxide and/or COS in the mercaptan-comprising gas stream. Therefore, sufficient nitrogen-containing base must be added to ensure that at any stage in the process a catalytic amount of unreacted or free nitrogen-containing base is present in the absorption medium as the absorption medium is contacted with the mercaptan-comprising gas stream. The required concentration of nitrogen-containing base can be determined based on the expected amount of base that will be necessary to reversible bond with any acid components in the gas stream. Based on the acid component content of the mercaptan-comprising gas stream and the volume of mercaptan-comprising gas stream contacted per unit absorption medium, the minimum amount of base required can be easily determined.

The absorption medium preferably is a liquid absorption medium, i.e. it is liquid under the conditions at which it is contacted with the mercaptan-comprising gas stream. The absorption medium may for instance be a liquid disulphide with the base dissolved therein or a liquid base with the disulphide dissolved therein.

The absorption medium may be in the form of a solution, suspension or emulsion. Preferably, the absorption medium is a liquid solution comprising the substituted disulphide and the nitrogen-containing base dissolved therein. More preferably, the absorption medium is an aqueous solution comprising the substituted disulphide and the nitrogen-containing base dissolved therein.

A preferred absorption medium is an aqueous amine-containing absorption liquid. Particularly suitable aqueous amine-containing absorption liquids are those that are generally used for removing so-called acid gases such as hydrogen sulphide, carbon dioxide and/or COS from a gas stream containing these compounds. These aqueous amine-containing absorption liquids have been extensively described in the art. See for instance A. L. Kohl and F. C. Riesenfeld, 1974, Gas Purification, 2nd edition, Gulf Publishing Co. Houston and R. N. Maddox, 1974, Gas and Liquid Sweetening, Campbell Petroleum Series.

On an industrial scale, such absorption liquids are in principal classified in two categories, depending on the mechanism to absorb the acidic components: chemical absorbents and physical absorbents. Reference herein to a chemical absorbent is to a liquid that absorbs an acid gas by a reversible chemical reaction. Reference herein to a physical absorbent is to a liquid that absorbs an acid gas by a physical solution/dissolution process, examples of physical absorbents include cyclo-tetramethylenesulfone and its derivatives, aliphatic acid amides, N-methylpyrrolidone, N-alkylated pyrrolidones and the corresponding piperidones, methanol, ethanol and mixtures of dialkylethers of polyethylene glycols or mixtures thereof. Physical absorbents are generally used in combination with chemical absorbents. Such combinations are referred to as mixed absorbents. Each absorbent has its own advantages and disadvantages with respect to features as loading capacity, kinetics, regenerability, selectivity, stability, corrosivity, heating/cooling requirements etc.

In the process according to the present invention chemical absorbent-based absorption liquids are preferred as they do not significantly absorb condensate components in the mercaptan-comprising gas stream. Reference herein to condensates is to C2⁺ hydrocarbons including BTX (benzene, toluene and xylene) components. Physical absorbents do absorb condensate components, thereby undesirably removing these valuable condensate components from the gas stream. Herein, reference to chemical absorbent-based absorption liquids is to absorption liquid that rely on a reversible chemical reaction to absorb an acid gas, in the absence of significant amounts of physical absorbents, preferably the chemical absorbent-based absorption liquids comprises in the range of from 0 to 15 wt % of a physical absorbent, more preferably of from 0 to 5 wt %, even more preferable 0 to 1 wt % of a physical absorbent based on the weight to the total absorbent.

The chemical absorbents, which are useful in the process of the present invention, preferably, comprise an aliphatic alkanolamine and a primary or secondary amine as activator, the action of which accelerates the rate of CO₂ absorption. The chemical absorbent may further comprise water or another suitable solvent. Preferred aliphatic alkanolamines include monoethanolamine (MEA), di-isoproponalamine (DIPONA) and tertiary alkanolamines, especially triethanolamine (TEA) and/or methyldiethanolamine (MDEA). Suitable activators include primary or secondary amines, especially those selected from the group of piperazine, methylpiperazine and morpholine. Preferably, the chemical absorbent comprises in the range of from 1.0 to 5 mol/l, more preferably from 2.0 to 4.0 mol/1 of aliphatic alkanolamine. Preferably, the chemical absorbent comprises in the range of from 0.5-2.0 mol/1, more preferably from 0.5 to 1.5 mol/1 of the primary or secondary amine as activator. Especially preferred is a chemical absorbent comprising MDEA and piperazine. Most preferred is a chemical absorbent comprising in the range of from 2.0 to 4.0 mol/1 MDEA and from 0.8 to 1.1 mol/1 piperazine. These chemical absorbent-based absorption liquids contain a nitrogen-containing base and have the additional advantage that they efficiently remove carbon dioxide, COS and hydrogen sulphide from the mercaptan-comprising gas stream, if present, in particular at high pressures.

In a preferred embodiment, the process according to the present invention is incorporated in a conventional amine-based separation process for removing hydrogen sulphide and carbon dioxide from a gas stream comprising hydrogen sulphide and/or carbon dioxide.

Reference herein to an amine-based separation process is to a process comprising an amine-containing absorption liquid. The amine based separation process is typically performed in an amine treating unit. Such amine treating units are well known for extracting hydrogen sulphide and/or carbon dioxide from gas stream. These amine treating units generally are based on a contactor (also referred to as absorber) for contacting a gaseous stream with a liquid absorbent. The amine based separation process is based on a washing process wherein a gas stream is washed with a chemical absorbent, in particular an aqueous amine solution. The gas stream is separated by chemical adsorption of certain components. i.e. hydrogen sulphide and carbon dioxide, in the gas stream (solvent extraction).

By adding, according to the present invention, a substituted disulphide to, and preferably dissolving it in, the amine-containing absorption liquid, the absorption medium comprising the substituted disulphide and nitrogen-containing base according to the present invention is obtained whereby the amine-containing absorption liquid provides both the absorption medium and the nitrogen-containing base.

By incorporating a process according to the present invention in an amine-based separation process as described herein above, advantageously not only R_{I}—SH mercaptans are removed from the mercaptan-gas stream, but also any hydrogen sulphide and carbon dioxide present in the gas stream may be removed without the need for a separate hydrogen sulphide and carbon dioxide removal process.

As mentioned herein above, during step (b) of the process R_{I}—SH mercaptans are removed from the mercaptan-comprising gas stream. At the same time, the absorption medium is loaded with the reaction products of the reaction between the R_{I}—SH mercaptans and the R_{II}—SS—R_{III}.

Preferably, the loaded absorption medium is regenerated and recycled back to step (b) of the process, while the desorbed mercaptans, and optionally hydrogen sulphide, carbon dioxide and COS, are retrieved separately.

Retrieving loaded absorption medium from step b) may, for example, be performed by removing it from a lower part, e.g. the bottom, of the vessel or column or other device in which step b) is performed. During regeneration the mercaptans, and optionally hydrogen sulphide, carbon dioxide and COS, are desorbed. The desorbed mercaptans, and optionally hydrogen sulphide, carbon dioxide and COS, may for example be retrieved by removing gas from a higher part, e.g. the top, of the vessel or column or other device in which step d) is performed. Retrieving regenerated absorption medium may, for example, be performed by removing it from a lower part, e.g the bottom, of the vessel or column or other device in which step d) is performed.

The reaction between the R_{I}—SH mercaptans and the R_{II} SS R_{III} is an equilibrium reaction. By withdrawing R_{I}—SH mercaptans in a regeneration step, the R_{I}—SH mercaptan absorption reaction is reversed and R_{I}—SH mercaptans are obtained.

The loaded absorption medium may be regenerated by stripping the loaded absorption medium with a gas, such as nitrogen or steam.

Preferably, the loaded absorption medium is regenerated by subjecting the absorption medium to an elevated temperature, preferably a temperature in the range of from 80 to 200° C., even more preferably of from 100 to 175° C. By subjecting the loaded absorption medium to an elevated temperature, the desorption process is advantaged and in addition, this allows for an efficient desorption of hydrogen sulphide, carbon dioxide and COS, if these were absorbed from the mercaptan-comprising gas stream.

Preferably, the loaded absorption medium is regenerated by stripping the loaded absorption medium with a gas at elevated temperatures, such as those temperatures mentioned herein above.

In case the process according to the present invention is incorporated in an amine-based separation process as described herein above, the regeneration process for regenerating the amine-based absorption liquid of the amine-based separation process may be used to regenerate the substituted disulphide in the absorption medium.

It is preferred that the nitrogen-containing base is retained in the phase that is recycled back to step (b).

The process according to the invention may be operated in batch, semi continuous or continuous mode. Preferably, the process is operated in continuous mode, more preferably by passing the mercaptan-comprising gas stream and separately a stream of absorption medium through a contactor, wherein both streams are continuously contacted. A mercaptan-depleted gas stream, (or second gas stream) is continuously retrieved from the contactor, while simultaneously a stream of loaded absorption medium is retrieved from the contactor. The stream of loaded absorption medium is preferably sent to a regeneration unit to be regenerated and recycled to the inlet of the contactor. The mercaptan-comprising gas stream and a stream of absorption medium are contacted counter-currently. By contacting the mercaptan-comprising gas stream and the stream counter-currently, the mercaptan-comprising gas stream is contacted with fresh or freshly regenerated absorption medium, comprising the highest amount of nitrogen-containing base prior to exiting the contactor. This significantly reduces that effect of any acid compounds in the mercaptan-comprising gas stream on the concentration of unbound base in the absorption medium.

The mercaptan-comprising gas stream is preferably contacted with the absorption medium at a temperature in the range of from 0 to 100° C., more preferably of from 10 to 70° C., even more preferably 20 to 60° C. By reducing the temperate the choice of absorption media becomes broader.

The mercaptan-comprising gas stream is preferably contacted with the absorption medium under any suitable pressure, preferably a pressure in the range of from 1 to 150 bar absolute, more preferably, 20 to 100 bar absolute, even more preferably 30 to 75 bar absolute.

In case of a continuous process wherein both mercaptan-comprising gas and the absorption medium are continuously contacted, the mercaptan-comprising gas may preferably be supplied to the process at any suitable ratio to the absorption medium. Preferably, the weight ratio of the mercaptan-comprising gas flow (kg_{gas}/h) to the flow of absorption medium (kg_{medium}/h) is in the range of from 0.1 to 100.

The substituted disulphide may be any substituted disulphide according to general formula (2): R_{II}—SS—R_{II}. R_{II} and R_{III} are carbon comprising substituents, which may be the same or different. Preferably R_{II} and R_{III} are the same.

R_{II} and R_{III} are selected from:

—(CH₂)ₙ—X

wherein n=1, 2 or 3, preferably 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2
   or
   wherein R_{II} and R_{III} are selected from:

—(CH₂)ₙ—CH(X)—(CH₂)ₘ—CH₃
wherein n=0, 1, 2, or 3 and m=0, 1, 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2.

When R_{II} and R_{III} are selected from —(CH₂)ₙ—X, n preferably is 2 or 3, and X preferably is OH.

Preferably R_{II} and R_{III} are selected from:

—(CH₂)ₙ—X

wherein n=1, 2 or 3, preferably 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2

More preferably R_{II} and R_{III} are selected from:

—(CH₂)ₙ—X

wherein n=1, 2 or 3, preferably 2 or 3 and
X=NR₂ or N⁺R₃ wherein R=H or CH₃
or
X=OR wherein R=H or —(CH₂O)ₙH or —(CH₂O)ₙCH₃ and
n=1 or 2

Even more preferably R_{II} and R_{III} are the same and selected from:

—(CH₂)ₙ—X

wherein n=1, 2 or 3, preferably 2 or 3 and
wherein X=OR
wherein R=H or —(CH₂O)ₙH or —(CH₂O)ₙCH₃ and n=1 or 2.

Preferably the absorption medium is an aqueous solution comprising the substituted disulphide and the base. More preferably the absorption medium is an amine-containing absorption liquid, preferably a chemical absorbent-based absorption liquid, preferably comprising an aliphatic alkanolamine and a primary or secondary amine as activator.

Preferably the process further comprising the steps:

c) retrieving the absorption medium from step b);
d) regenerating the absorption medium
e) providing the regenerated absorption medium to step b).

Preferably wherein the disulphide mixture in step d) is regenerated by subjecting the absorption medium to an elevated temperature, preferably a temperature in the range of from 80 to 200° C., even more preferably of from 100 to 175° C.

The mercaptan-comprising gas stream may be any gas stream comprising mercaptans. Preferably, the mercaptan-comprising gas stream is natural gas. Reference herein to natural gas is to a gas, which generally comprises mainly methane and can further comprise other components such as higher hydrocarbons. The higher hydrocarbons are typically referred to as condensate or condensate components and may include e.g. ethane, propane, butanes, pentanes, benzene, toluene and xylenes. Natural gas may further include components such as nitrogen, carbon dioxide, sulphur contaminants and mercury. The amount and type of sulphur contaminants can vary. Common sulphur contaminants are hydrogen sulphide (H₂S), mercaptans (RSH) and carbonyl sulphide (COS).

It will be appreciated that the composition of the natural gas stream depends on the natural gas field it is extracted from. Typically, the natural gas comprises predominantly methane, preferably in the range of from 40 to 99 vol % methane, more preferably 60 to 99 vol % methane, more preferably 60 to 99 vol % methane, based on the total mercaptan-comprising natural gas stream.

Preferably, the amount of mercaptans in the gas stream supplied to process is in the range of from 1 ppmv to 5 vol %, based on the total mercaptan-comprising gas stream, preferably from 5 ppmv to 5 vol %, more preferably from 6 ppmv to 3 vol %, still more preferably from 10 ppmv to 1500 ppmv.

The mercaptan-comprising gas stream may also comprise other components such as one or more of hydrogen sulphide, carbon dioxide, water, C² hydrocarbons or COS. Preferably, the gas stream comprises no or essentially no oxygen (less than 1 ppm).

In case the mercaptan-comprising gas stream comprises hydrogen sulphide, the mercaptan-comprising gas stream preferably comprises up to 50 vol %, more preferably in the range of from 0.1 ppmv to 50 vol %, even more preferably of from 0.2 to 25 vol % of hydrogen sulphide, based on the total mercaptan-comprising gas stream.

Preferably, the mercaptan-comprising gas stream comprises in the range of from 0 to 40 vol % carbon dioxide, preferably of from 0 to 30 vol % carbon dioxide, based on the total mercaptan-comprising gas stream.

In case the mercaptan-comprising gas stream comprises COS, the mercaptan-comprising gas stream preferably comprises in the range of from 0.1 to 5000 ppmv, more typically 0.1 ppmv to 2500 ppmv of COS, based on the total mercaptan-comprising gas stream.

In case the mercaptan-comprising gas stream comprises mercury it is preferred that the mercury is removed.

Preferably, the mercaptan-comprising gas stream comprises little to no hydrogen and/or carbon monoxide, more preferably no more than 20 vol % based on the total volume of the mercaptan-comprising gas stream, even more preferably, no more than 1 vol % hydrogen and/or carbon monoxide. At prolonged contact times these components may irreversibly react with some of the disulphide.

The invention is illustrated by the following non-limiting examples.

### Examples

The performance of disulfides was tested in a bench-scale unit.

Gas containing about 250 ppm methyl mercaptan, 1 vol % hydrogen sulfide and 0.25 vol % isobutane in nitrogen entered an absorption zone at 500 Nl/hr. Solvent entered counter-currently the absorption zone at 0.8 kg/hr. The temperature of the solvent at the solvent inlet was about 40° C.

The gas containing mercaptan was contacted with a solvent in the absorption zone. The pressure in the absorption zone was about 40 bar.

Solvent was regenerated in a regeneration zone at about 2 bar and about 125° C. in the presence of 30 Nl/hr of nitrogen which served as stripping gas. Lean solvent was cooled and sent back to the absorption zone.

Three different solvents were tested, see Table 1. Solvent A is a benchmark solvent. With solvent B a comparative example was obtained. Solvent C is according to the invention.

TABLE 1

| | Solvent A | | Solvent B | | Solvent C | |
|---|---|---|---|---|---|---|
| MDEA | 50 | wt % | 49.25 | wt % | 49.44 | wt % |
| water | 50 | wt % | 49.25 | wt % | 49.44 | wt % |
| Potassium salt of 3,3′- | 0 | wt % | 0 | wt % | 1.12 | wt % |
| dipropanoicacid-disulfide | | | | | | |
| (MW = 286.45 g/mol) | | | | | | |
| Potassium salt of | 0 | wt % | 1.50 | wt % | 0 | wt % |
| di(4-carboxyphenyl) disulfide | | | | | | |
| (MW = 382.54 g/mol) | | | | | | |

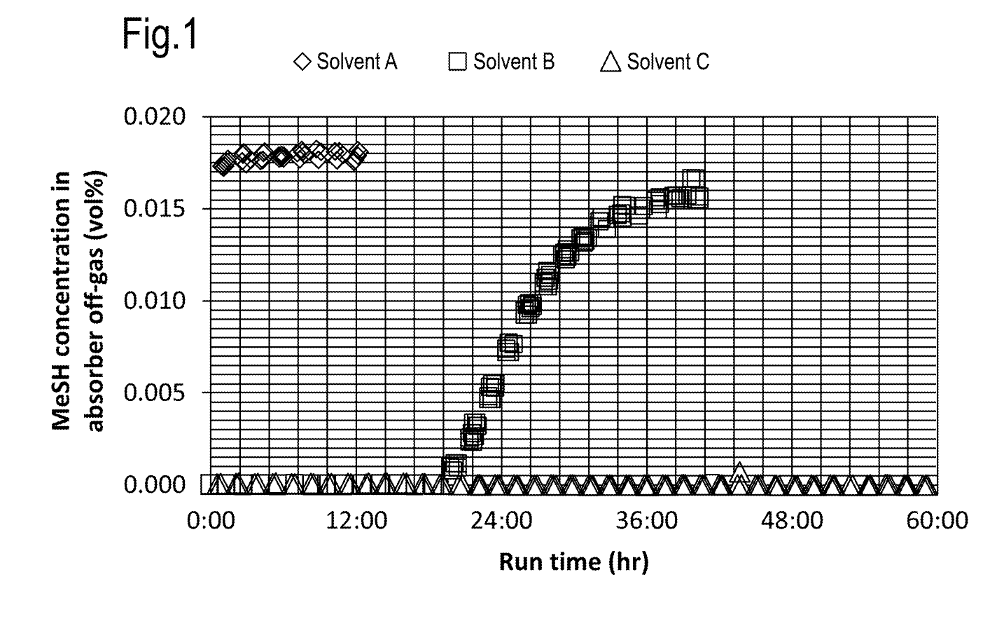

The methyl mercaptan concentration in the absorber off-gas as a function of run time is shown in FIG. 1.

FIG. 1 clearly shows that addition of a disulfide improves the methyl mercaptan capture performance of the solvent as compared to the benchmark solvent A.

Solvent B shows breakthrough of methyl mercaptan after approximately 20 hours run time after which the methyl mercaptan concentration rapidly increases to the levels observed for Solvent A.

Tests with Solvent C did not result in methyl mercaptan breakthrough during the duration of the test (approximately 60 hours), thereby clearly demonstrating its superior performance in continuous operation with respect to solvent B.

The test results are also shown in Table 2

TABLE 2

| | Solvent | | |
|---|---|---|---|
| | A | B | C |
| Onset of MeSH breakthrough | 0 | 20 hours | >60 hours |

Other examples performed with potassium salt of 3,3′-dipropanoicacid-disulfide in batch mode showed a MeSH breakthrough after 2 hours. This clearly demonstrates the superior performance when operating a solvent according to the present invention counter-currently.

1. A process for removing mercaptans from a gas stream gas stream, comprising the steps:
a) providing a first mercaptan-comprising gas stream comprising at least a mercaptan of the general formula:
R_{I}—SH
wherein R_{I} is an alkyl group comprising 1 to 4 carbon atoms; and
b) contacting the mercaptan-comprising gas stream counter-currently with an absorption medium comprising
a substituted disulphide, and
a nitrogen-containing base in an amount of at least 3 mol % with regard to the amount of the substituted disulfide
to obtain a second mercaptan-depleted gas stream,
c) retrieving the absorption medium from step b);
d) regenerating the absorption medium;
e) providing the regenerated absorption medium to step b);
wherein:
the amount of the substituted disulphide constitutes 0.001-10% m/m of the absorption medium; and
the substituted disulphide is of the general formula
R_{II}—SS—R_{III}
wherein:
R_{II} and R_{III} are carbon comprising substituents, which may be the same or different, and
wherein R_{II} and R_{III} are selected from:
—(CH₂)ₙ—X
wherein n=1, 2 or 3, preferably 2 or 3 and
X=CO(O)H,
or
X=NR₂ or N⁺R₃ wherein R=H or CH₃
or
X=OR wherein R=H or —(CH₂O)ₙH or —(CH₂O)ₙCH₃ and
n=1 or 2
or
wherein R_{II} and R_{II} are selected from:
—(CH₂)ₙ—CH(X)—(CH₂)ₘ—CH₃
wherein n=0, 1, 2, or 3 and m=0, 1, 2 or 3 and
X=CO(O)H,
or
X=NR₂ or N±R₃ wherein R=H or CH₃
or
X=OR wherein R=H or —(CH₂O)ₙH or —(CH₂O)ₙCH₃ and
n=1 or 2.

2. The process according to claim 1, wherein R_{II} and R_{III} are the same.

3. The process according to claim 1, wherein R_{II} and R_{III} are selected from:
—(CH₂)ₙ—X
wherein n=1, 2 or 3, preferably 2 or 3 and
X=CO(O)H,
or
X=NR₂ or N±R₃ wherein R=H or CH₃
or
X=OR wherein R=H or —(CH₂O)ₙH or —(CH₂O)ₙCH₃ and
n=1 or 2

4. The process according to claim 3, wherein
X=NR₂ or N±R₃ wherein R=H or CH₃
or
X=OR wherein R=H or —(CH₂O)ₙH or —(CH₂O)ₙCH₃ and
n=1 or 2.

5. The process according to claim 4, wherein the substituted disulphide is of the general formula
R_{II}—SS—R_{III}
wherein:
R_{II} and R_{III} are carbon comprising substituents, which are the same and
wherein R_{II} and R_{III} are selected from:
—(CH₂)ₙ—X
wherein n=1, 2 or 3, preferably 2 or 3
wherein X=OR
wherein R=H or —(CH₂O)ₙH or —(CH₂O)ₙCH₃ and n=1 or 2.

6. The process according to claim 1, wherein the regenerated absorption medium obtained in step d) is not subjected to oxidation before step e).

7. The process according to claim 1, wherein the absorption medium is an aqueous solution comprising the substituted disulphide and the base.

8. The process according to claim 1, wherein the absorption medium is an amine-containing absorption liquid, preferably a chemical absorbent-based absorption liquid, preferably comprising an aliphatic alkanolamine and a primary or secondary amine as activator.

9. The process according to claim 1, wherein the disulphide mixture in step d) is regenerated by subjecting the absorption medium to an elevated temperature, preferably a temperature in the range of from 80 to 200° C., even more preferably of from 100 to 175° C.
